(19) United States
(12) Patent Application Publication
(10) Pub. No.: US 2017/0186102 A1
(43) Pub. Date: Jun. 29, 2017

(54) NETWORK-BASED PUBLICATIONS USING FEATURE ENGINEERING

(71) Applicant: LinkedIn Corporation, Mountain View, CA (US)

(72) Inventors: Wei Di, Cupertino, CA (US); Ho Jeong Kim, Belmont, CA (US)

(21) Appl. No.: 14/982,671

(22) Filed: Dec. 29, 2015

(51) Int. Cl. G06Q 50/00; G06N 99/00; H04L 29/08

(52) U.S. Cl. CPC G06Q 50/01; H04L 67/10; G06N 99/005

(57) ABSTRACT

A content analysis system includes one or more hardware processors, a memory storing historical content engagement information associated with a user, a user summary, first and second content items including content summaries, and a content analysis engine. The content analysis engine is configured to identify a past content item from the historical content engagement information, combine the user summary and the past content item into a combined summary, apply the combined summary to a model, thereby generating a user vector having a plurality of terms, each term representing a word or word-phrase in a dictionary of terms, apply the first content item and second content item to the model, thereby generating first and second item vectors, compare the user vector with the first item vector and the second item vector and, based on the comparing, select the first content item for presentation to the user.

### TECHNICAL FIELD

This application relates generally to the technical field of publications in a social network and, in one specific example, to systems and methods for providing publications to users within a target network.

### BACKGROUND

Some business-oriented social networking sites enable users to “share” publications with other users of the networking site. In some situations, it may be advantageous to foster the sharing of content between users. For example, a social networking site with greater sharing of content between users is a more vibrant and engaging environment for its users.

### BRIEF DESCRIPTION OF THE DRAWINGS

Some embodiments are illustrated by way of example and not limitation in the figures of the accompanying drawings.

FIG. 1 is a network diagram illustrating a network environment suitable for a social network service implementing a content analysis engine (not separately shown in FIG. 1), according to some example embodiments.

FIG. 2 is a block diagram illustrating components of an example social network system (e.g., providing the social network service(s)), according to some example embodiments.

FIG. 3 is a diagram of the example content analysis engine shown in FIG. 2.

FIG. 4 is a data flow diagram illustrating the model module constructing (or “training”) a recommendation model (or just “model”) from a training set.

FIG. 5 is a data flow diagram illustrating the content analysis engine applying the model to evaluate relevance of the current content items to a user.

FIG. 6 is a flow chart illustrating operations of the skills analysis engine in performing a method for evaluating relevance of content items for a user of a social network, according to various embodiments.

FIG. 7 is a block diagram illustrating components of a machine, according to some example embodiments, able to read instructions from a machine-readable medium and perform any one or more of the methodologies discussed herein.

### DETAILED DESCRIPTION

Example methods and systems are directed to techniques for providing publications in a social network system. More specifically, in one example embodiment, methods, systems, and computer program products are provided for providing content relevant to users of the social network system. The social network system provides members an easy way to discover relevant and insightful content within topics of interest, and then share that content to their social network (e.g., their first-degree connections). The social network system may provide a facility to compartmentalize and communication with a subset of users, such as a company-oriented network (e.g., a community including the employees of a business entity, or a particular user's social network). For example, the social network system may enable company-oriented social sharing, in which co-workers may share content with each other, or network-oriented social sharing, in which the user shares content with their social networks. Such content, for example, may be selected, reviewed, moderated, and/or curated by the company, or may be recommended by curators of the content. This forum for content sharing enables users to receive content hand-picked by people within the community (a target network, e.g., a group of employees), allowing a greater confidence level that the content is of a higher degree of relevance, most relevant to their own work, more likely to be within the interests of the community, provides improved branding for both the individuals and the organization, and fosters employee sharing, which provides an authentic voice for the company.

In one example embodiment, the social network system enables the community or target network (e.g., the company, or entities within the company, or a user's social network) to provide a periodic content distribution to community members (e.g., a weekly marketing email to the user's social network, or a daily digest email to the company's employees). The content distribution may include multiple content items (“current content items”), each of which, individually, may be of more or less interest to a particular community member or “target user.” In other words, and for example, some content items may be more relevant to a particular employee, while other content items may be less relevant to that employee. Thus it is advantageous to elevate the presentation of certain content items over others to that particular community member.

A content analysis system is provided herein. The content analysis system includes a content analysis engine that evaluates relevance of each of the current content items to the target user(s) (e.g., the various employees which may be targeted recipients of the current content items). More specifically, the content analysis engine evaluates each target user based on “user summary information,” or a summary description for that user (e.g., personal headline, summary, specialties, as identified in the social network), as well as “historical content engagement information,” or that user's past content consumption and content sharing history (e.g., past content items, such as articles or posts, that the user has viewed or shared). Further, the content analysis engine evaluates each current content item based on text describing the subject matter of that current content item (e.g., a title, a description or abstract associated with the content item). The content analysis engine compares similarity between the user and each of the current content items to determine the most relevant content for the user. The content analysis engine then presents the most relevant content items to the user based on the similarity comparison.

To evaluate user relevance, in an example embodiment, the content analysis engine uses term frequency—inverse document frequency (TF-IDF) to build a user vector for each target user based on bi-grams (e.g., single words, or pairs of words) from both the user summary information and the historical content engagement information for that target user. More specifically, the content analysis engine identifies past content items from the target user's content engagement and sharing history (e.g., the past month, or past three months, of content items viewed or shared by the user). Each past content item includes a content summary (e.g., an abstract about the content item, a user-provided short description of the contents of the content item). Content summaries from each of these past content items are combined (e.g., concatenated) together with the user summary information and used as the input for a TF-IDF model of that target user. The model transforms these concatenated texts into a “user vector” that is used by the content analysis engine to gauge the relevance of current content items to that target user. Each term in the user vector represents a one- or two-word term from the term dictionary, and the value (e.g., the weight) for each term is the TF-IDF computed value of that term across the term dictionary.

For each current content item, the content analysis engine also generates an “item vector” using the same TF-IDF model. More specifically, each current content item includes a content summary (e.g., a title, an abstract about the content item, a user-provided short description of the contents of the content item). Each content summary is provided as input to the model to generate the item vector for that current content item. As such, each current content item has a content item vector based on the same dictionary as the user vector.

Once the user vector is created for the target user, and the item vectors are created for each of the current content items, the content analysis engine evaluates each of the item vectors against the user vector. This evaluation generates a similarity score for each item vector (e.g., for each current content item, relative to that target user). The content analysis engine then provides one or more of the current content items to the target user based on the relative similarity scores. For example, the content analysis engine may present the top 5 content items, or only content items with a similarity score above a pre-determined threshold. This may be done for each user in the community, such that the content analysis engine generates a custom selection of content items from a set of content items, where the selection is individualized or tailored specifically to each member.

Examples provided herein merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

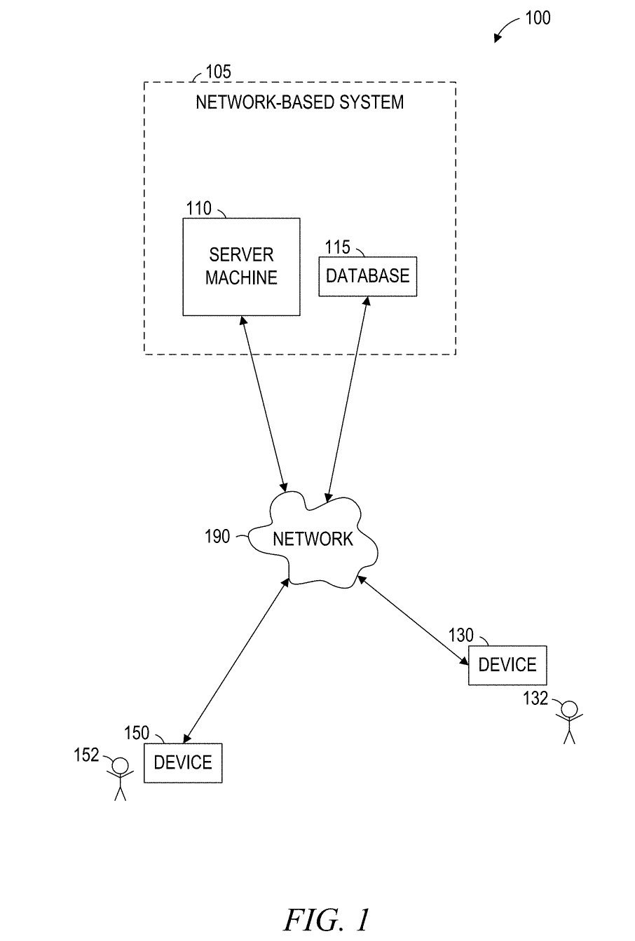

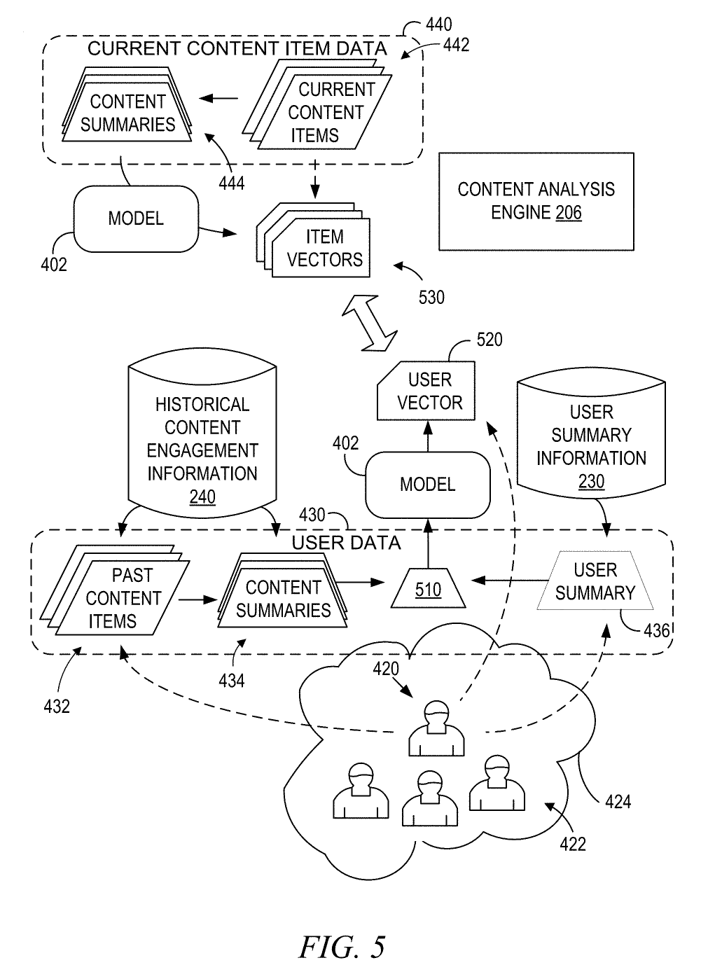

FIG. 1 is a network diagram illustrating a network environment 100 suitable for a social network service implementing a content analysis engine (not separately shown in FIG. 1), according to some example embodiments. The network environment 100 includes a server machine 110, a database 115, a first device 130 for a first user 132, and a second device 150 for a second user 152, all communicatively coupled to each other via a network 190. The server machine 110 and the database 115 may form all or part of a network-based system 105 (e.g., a cloud-based server system configured to provide one or more services to the devices 130 and 150) that may also provide the skills analysis engine described herein. The database 115 can store member data (e.g., profile data, social graph data) for the social network service. The server machine 110, the first device 130, and the second device 150 may each be implemented in a computer system, in whole or in part, as described below with respect to FIG. 5.

Also shown in FIG. 1 are the users 132 and 152. One or both of the users 132 and 152 may be a human user (e.g., a human being), a machine user (e.g., a computer configured by a software program to interact with the device 130 or 150), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, the user 152 is not part of the network environment 100, but is associated with the device 150. As an example, the device 150 may be a desktop computer, a vehicle computer, a tablet computer, a navigational device, a portable media device, a smartphone, or a wearable device (e.g., a smart watch or smart glasses) belonging to the user 152.

Any of the machines, databases 115, or devices 130, 150 shown in FIG. 1 may be implemented in a general-purpose computer modified (e.g., configured or programmed) by software (e.g., one or more software modules) to become a special-purpose computer configured to perform one or more of the functions described herein for that machine, database 115, or device 130, 150. For example, a computer system able to implement any one or more of the methodologies described herein is discussed below with respect to FIG. 5. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases 115, or devices 130, 150 illustrated in FIG. 1 may be combined into a single machine, database 115, or device 130, 150, and the functions described herein for any single machine, database 115, or device 130, 150 may be subdivided among multiple machines, databases 115, or devices 130, 150.

The network 190 may be any network that enables communication between or among machines, databases 115, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., a Wi-Fi network or WiMAX network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

In the example embodiment, the network-based system 105 provides content analysis services to the users 132, 152 of the social network service. The users 132, 152 may be members of the social network service and, in some embodiments, may be members of a community, such as employees of a shared business entity (e.g., a corporation). The content analysis engine described herein may, thus, provide content analysis and selection for the users 132, 152 (e.g., based on content relevance).

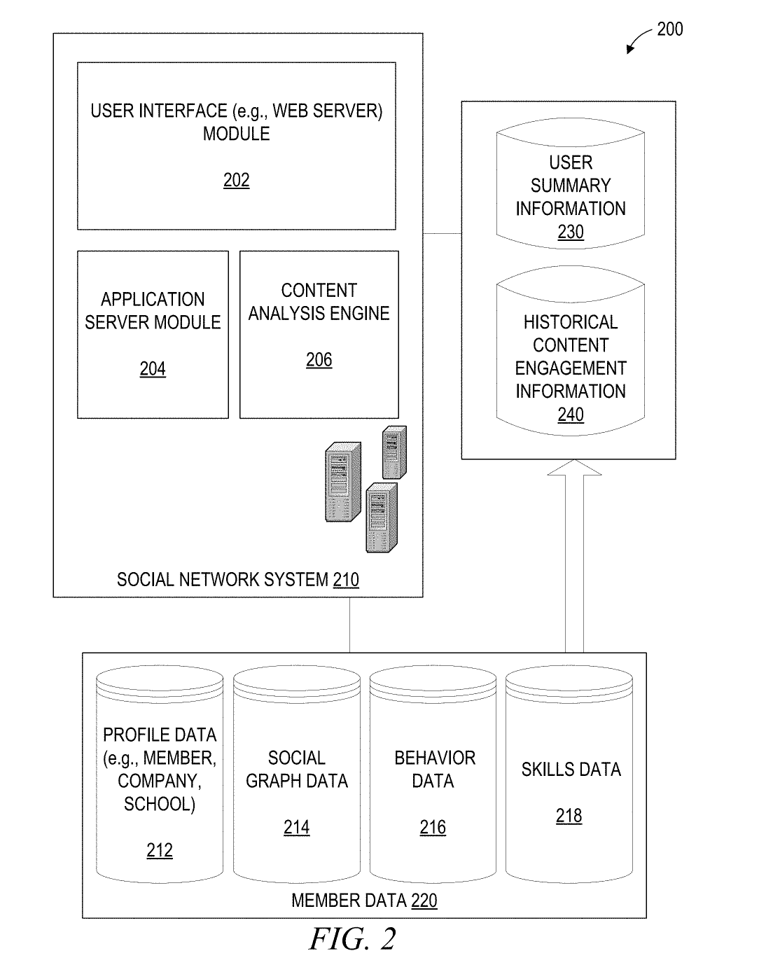

FIG. 2 is a block diagram illustrating components of an example social network system 210 (e.g., providing the social network service(s)), according to some example embodiments. The social network system 210 is an example of the network-based system 105 of FIG. 1. The social network system 210 includes a user interface module 202, an application server module 204, and a content analysis engine 206, all configured to communicate with each other (e.g., via a bus, shared memory, a communications network, or the like).

The social network system 210 (e.g., as provided by the network-based system 105) may provide a broad range of applications and services (the “social networking service(s)”) that allow members (e.g., users 132 and 152) the opportunity to share and receive information, often customized to the interests of the targeted member. For example, the social networking service may include a photo sharing application that allows members to upload and share photos with other members. In some example embodiments, members may be able to self-organize into groups (e.g., interest groups) organized around a subject matter or topic of interest, or some of the social networking services may host various job listings providing details of job openings with various organizations (e.g., companies).

The social network system 210 communicates with the database 115 of FIG. 1, such as a database storing member data 220, and a database storing user summary information 230 and historic content engagement information 240. The member data 220 can include profile data 212 (e.g., the member's employer, position, educational information, and so forth), social graph data 214 (e.g., contacts and connections with other members), behavior data 216 (e.g., actions performed within the social network, such as in-network mail, or interactions with in-network advertisements or content items), and skills data 218 (e.g., job skills information, job descriptions of past and current employment positions, and so forth).

The user summary information 230 includes summary text for individual members (e.g., describing the user's high-level skills, current job position or title, attributes, interests, member attributes, and the like). The user summary information 230 may be extracted or otherwise retrieved from the profile data 212 (e.g., a summary field for the user) or skills data 218. The user summary information 230 often contains valuable profession information about the user, such as her recent area of focus, or projects of interest. For example a technical engineer may mention in her summary information that she worked on a webpage building, or Hadoop large scale data analysis, while a graphical designer may mention in her summary that she worked on design projects that included a magazine cover or graphics in a book chapter. In some embodiments, the user summary information 230 may include success messages or phrases relative to the user's job function. For example, if the user is a sales person, a typical success phrase may be “beat quota” and, as such, this success phrase may be included in the summary text. Accordingly, the user summary information 230 enables the content analysis engine 206 to tailor content item recommendations that are most relevant to the user (e.g., based on their job needs, interests, or profession background).

The historical content engagement information 240 includes historical information regarding user interaction (e.g., clicking on, sharing, impressions, and so forth) with content items (e.g., articles, posts) presented by the social network system 210 to the various members (e.g., users 132, 152). For example, historical content engagement information 240 for a particular user 132 may include a list of content items that the user 132 has clicked on, or shared with her network, or commented on, timestamp information for those engagement events, content summaries of those content items, and so forth. Use of the historical content engagement information 240 enables the content analysis engine 206 to tailor content item recommendations based on interests expressed based on engagement. By looking at recent past activity, for example, content item recommendations may be shifted toward subject matter of recent interest to the user. For example, presume a user with a technical background has previously been focusing their attentions on technical-related news, such as anything related to camera or optical development. However, that user has recently developed an idea to start her own business in this field, and has started engaging with entrepreneurship and venture capital funding news articles. By looking at her most recent activity, the content analysis engine 206 may shift the content item recommendations to include business start-up type content, thereby including such content items in the recommendations.

As shown in FIG. 2, database 115 can include several databases for member data 220. The member data 220 includes a database for storing the profile data 212, including both member profile data and profile data for various organizations. Additionally, the member data 220 can store the social graph data 214, the behavior data 216, and the skills data 218. Further, the database 115 may also store the user summary information 230 and/or the historical content engagement information 240.

The profile data 212 can include member attributes used in providing leads by the lead generation module 206. For instance, with many of the social network services provided by the social network system 210, when a user 132, 152 registers to become a member, the member is prompted to provide a variety of personal and employment information to be displayed in the member's personal web page. Such information is commonly referred to as member attributes. The member attributes that are commonly requested and displayed as part of a member's profile includes the member's age, birthdate, gender, interests, contact information, residential address, home town and/or state, spouse and/or family members, educational background (e.g., schools, majors, matriculation and/or graduation dates, etc.), employment history, office location, skills, professional organizations, and so on. In some embodiments, the member attributes may include the various skills that each member has indicated he or she possesses. Additionally, the member attributes may include skills for which a member has been endorsed.

With certain social network services, such as some business or professional network services, the member attributes may include information commonly included in a professional resume or curriculum vitae (CV), such as information about a person's education, the company at which a person is employed, the location of the employer, an industry in which a person is employed, a job title or function, an employment history, skills possessed by a person, professional organizations of which a person is a member, and so on.

Some of these member attributes may also be included as a part of skills data 218 (e.g., skills provided directly by the member), while other skills data 218 may be provided from other sources (e.g., skills for which the member has been endorsed, skills derived by the social network system 210 from job descriptions provided by the member for current and past employment, resume, CV, and so forth). Skills data 218 includes titles of skills for which the member is somehow associated (e.g., through past employment experience with the skill, through skills endorsements, and so forth). For purposes of the present disclosure, skills data 218 is presumed present, however received, entered, derived, or otherwise acquired.

Another example of the profile data 212 can include data associated with a company page. For example, when a representative of an entity initially registers the entity with the social network service, the representative may be prompted to provide certain information about the entity. This information may be stored, for example, in the database 115 and displayed on an entity page. This type of profile data 212 can also be used in the forecasting models described herein.

Additionally, social network services provide their users 132, 152 with a mechanism for defining their relationships with other people. This digital representation of real-world relationships is frequently referred to as a social graph.

In addition to hosting a vast amount of social graph data 214, many of the social network services offered by the social network system 210 maintain behavior data 216. The behavior data 216 can include an access log of when a member has accessed the social network system 210, profile page views, entity page views, newsfeed postings, interactions with target offerings (e.g., presentations of advertisements to the member), and clicking on links on the social network system 210. For example, the access log can include the last logon date, the frequency of using the social network system 210, and so on.

Additionally, the behavior data 216 can include information associated with applications and services that allow members the opportunity to share and receive information, often customized to the interests of the member. In some embodiments, members may be able to self-organize into groups, or interest groups, organized around subject matter or a topic of interest.

Any one or more of the modules or engines described herein may be implemented using hardware (e.g., one or more processors of a machine) or a combination of hardware and software. For example, any module or engine described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database 115, or device 130, 150 may be distributed across multiple machines, databases 115, or devices 130, 150.

As will be further described below, the content analysis engine 206 provides content analysis services to the users 132, 152 (e.g., members) in the social network system 210 and associated services.

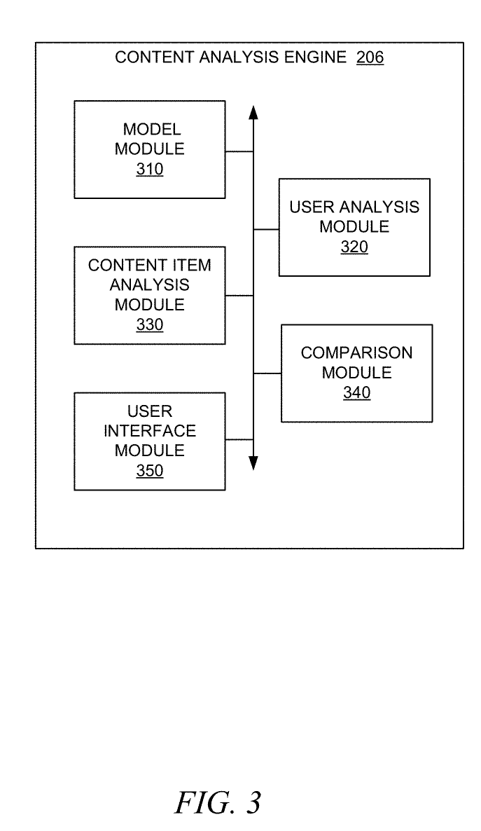

FIG. 3 is a diagram of the example content analysis engine 206. In the example embodiment, the content analysis engine 206 includes a model interface module 310, a user analysis module 320, a content item analysis module 330, a comparison module 340, and a user interface module 350.

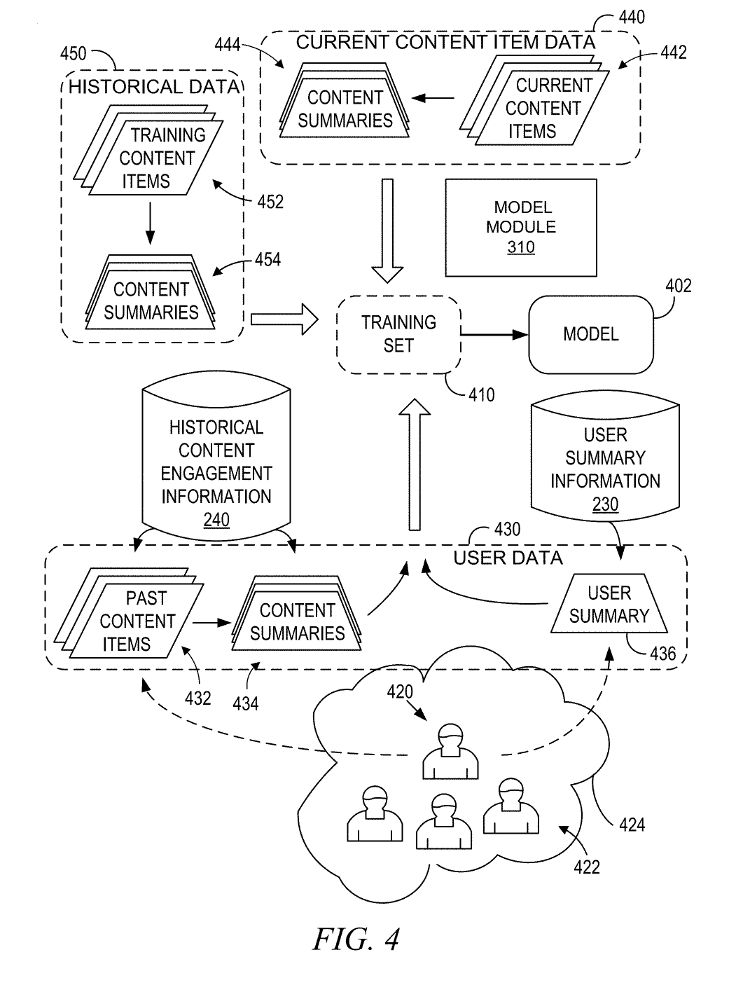

The model module 310 builds models for the content analysis engine 206, as well as applies inputs to the models to generate outputs. In one example embodiment, the model module 310 builds or “trains” a term frequency—inverse document frequency (TF-IDF) model using a “training set” of historical content items (or “training content items,” e.g., articles or posts on the social network system 210 over a time period, such as the last month or the last 3 months). Model building is described in greater detail with regard to FIG. 4 below. Application of the model is described in greater detail with regard to FIG. 5 below.

The user analysis module 320 identifies data associated with a target user, such as the users 132, 152, that will be used to provide as input to the model to create a “user vector” for the target user. The target user data includes user summary information 230 (e.g., a user summary) and historical content engagement information 240 (e.g., past content items and associated content summaries). The user analysis module 320, in conjunction with the model module 310, applies the target user data to the model to generate the user vector.

The content item analysis module 330 identifies data associated with a set of current content items (e.g., content items that are candidates to be presented to the target user, and for which the content analysis engine 206 is evaluating relevance with regard to the target user). The current content items' data includes content summaries for each of the current content items. The content item analysis module 330, in conjunction with the model module 310, applies the current content items' data to the model to generate an “item vector” for each current content item.

The comparison module 340 compares the user vector to the item vectors to evaluate relevance of each particular current content item to the target user. The user interface module 350 provides an interface to the target users and/or administrators for displaying or otherwise providing the results of the systems and methods described herein.

FIG. 4 is a data flow diagram illustrating the model module 310 constructing (or “training”) a recommendation model (or just “model”) 402 from a training set 410. The model 402, once built, may be used by the model module 310 or, more broadly, the content analysis engine 206, to evaluate relevance between a user 420 and one or more current content items 442 (e.g., multiple articles or posts which may be presented to the user 420). FIG. 4 shows the various sources of training data that forms the training set 410 used to construct the model 402. The sources of training data include user data 430, current content item data 440, and historical data 450.

User data 430 includes data related to the user 420, and may include data related to multiple users 420, 422 that are associated with each other in some capacity. In the example embodiment, the users 420, 422 are each members of a community or group 424 within the social network system 210 (e.g., they all may be employees of a particular business entity, or employees within a particular department or division of the business entity, or any grouping in which users may be associated).

For each user 420, 422 in the group 424 (e.g., the user 420, for purposes of explanation), the content analysis engine 206 (e.g., the model module 310) identifies two types of user data 430 related to that user 420. First, a user summary 436 (e.g., from the user summary information 230) is identified for the user 420. The user summary 436 may be any set of information that describes the user 420, such as data that describes the user's high-level skills, current job position or title, attributes, interests, member attributes, and the like, and any combination thereof. In the example embodiment, the user summary 436 is collected from member profile information of the user 420 within the social network system 210 (e.g., profile data 212 and/or skills data 218). Because of its nature, this type of data is relatively static (e.g., does not change much over time, as most members' jobs and skillsets do not get radically change, but instead may be added to or augmented, and often within a related field). As such, the example user summary 436 represents a relatively static component of the user data 430 that includes a set of text (e.g., words, phrases, sentences, and so forth) specific to the user 420.

The user data 430 for each user 420 in the group 424 also includes a more dynamic component derived from historical content engagement information 240. Over time, each user 420 generates a history of past content items 432 with which that user 420 has engaged or consumed in some respect. In the social network system 210, for example, the user 420 may read articles (e.g., as manifested by clicking on an article shared with the user 420 from another community user 422), or generate articles or posts (e.g., uploading or otherwise inputting an article or post on the social network system 210 that may be shared with and consumed by other community users 422), or share articles or posts of others (e.g., sharing articles or posts within, or into, or out of the community 424). Each of these are examples of past content items 432 with which the user 420 has engaged.

In some embodiments, the text of the past content items 432 may be provided as user data 430 to the training set 410. However, the size of the past content items 432 (e.g., the total number of words) may be large and, as such, may prove too computationally burdensome for some computing environments or settings.

Accordingly, and in the example embodiment, the content analysis engine 206 uses content summaries 434 in lieu of the full text of the past content items 432. More specifically, each past content item 432 includes an associated content summary 434. The content summary 434 represents a text summary of the associated past content item 432. The content summary 434 may include, for example, a title of the content item, a brief description (e.g., 50 words or less) of the content item (e.g., an abstract of an article, or a short description of a post provided by an author or sharer of the post), one or more categories associated with the content item, or other summary type data. For example, a thousand-word article may include a 50-word summary (e.g., and abstract) that may be used to represent that article in the model building process. In some embodiments, the social network system 210 may collect and store the content summaries 434 at the time the content item is first posted or uploaded to the social network system 210.

In some embodiments, the content analysis engine 206 may implement a hybrid approach between using content summaries 434 and the full text of the past content items 432. For example, the content analysis engine 206 may include a pre-defined threshold word count that defines when the content summary 434 for a given past content item 432 is used, or when the full text of that past content item 432 is used (e.g., if the past content item 432 is less than 50 words, then the full text may be used, otherwise the content summary 434 is used). In some embodiments, the presence and/or absence of an associated content summary 434 for a given past content item 432 may be used. For example, if a content summary 434 exists for a given past content item 432, then that content summary 434 may be used, otherwise the full text of the past content item 432 may be used.

The scope of selected past content items 432 may include all past content items 432 (e.g., and/or associated content summaries 434). However, this may contribute to a very large training set 410 that may prove too computationally burdensome for some computing environments or settings. As such, in the example embodiment, the content analysis engine 206 limits the scope of the past content items 432. For example, the past content items 432 may be limited to just the past content items 432 consumed or otherwise engaged by the user 420 in the last month, or in the last three months. This temporal limitation may help provide greater relevance as, for example, recently consumed content items 432 may indicate greater relevance at this time for the user 420 than a content item 432 consumed 2 years prior. In some embodiments, the content analysis engine 206 may limit the past content items 432 based on an activity of the user. For example, some users may be more active (e.g., frequently sharing, posting) than others. As such, the past content items 432 may be selected, either in addition to temporal limitations, or alternately, based on user activity levels (e.g., up to a pre-defined threshold of past content items 432). Limiting the number of past content items 432 may provide computational efficiencies in building the model 402 by limiting the size of the training set 410.

Accordingly, the user data 430 includes relatively-static content (e.g., the user summary 436) as well as relatively-dynamic content (e.g., the content summaries and/or past content items 432) for the user. The user data 430 is thus provided as at least a part of the training set 410 used to construct the model 402. In some embodiments, only user data 430 for a single user (e.g., the user 420) is provided as the user data 430 portion of the training set 410. As such, the model 402 would be relatively tailored for that particular user 420 (e.g., only that user's 420 user data 430 would impact the training of the model 402). In the example embodiment, user data 430 for each user 420, 422 in the community 424 is determined and provided as the user data 430 portion of the training set 410. As such, the model 402 is tailored for that particular community 424.

Returning to the sources for the training set, the model module 310 may include current content item data 440 in the training set 410. Current content item data 440 includes current content items 442. The current content items 442 include multiple current content items 442 that may be presented to the user 420. In other words, the current content items 442 represent the set of content items that are under consideration for relevance to the user 420. For example, presume a company has identified a pool of articles for which it targets publication to its employees (e.g., the users 420, 422 of the community 424 of company employees). Similar to the content summaries 434 of past content items 432, the current content items 442 may also have associated content summaries 444. And similarly, in the example embodiment, the content summaries 444 are included in the training set 410 (e.g., in lieu of the full text of the current content items 442). In other embodiments, just as with the past content items 432, the model module 310 may use some mix of content summaries 444 and/or current content items 442 (e.g., based on a word count threshold, or the presence or absence of associated content summaries). As such, the model 402 is tailored also to the current content items 442.

In some embodiments, historical data 450 may also be included in the training set 410. Historical data 450 includes training content items 452 which represent content items not necessarily already included in either the past content items 432 or the current content items 442. In other words, the training content items 452 may be unrelated content items, for example, used to build a broader model 402 not necessarily as tailored to either the specific users 420, 422 or the specific current content items 442. And in some embodiments, similar to the current content items 442 and past content items 432, the training content items 452 may include content summaries 454 that may be used in lieu of the full text of the training content items, and optionally with uses similar to the current content items 442 and past content items 432 (e.g., exclusively using content summaries 454, or the full text of the training content items 452, or a mix of the two, and optionally based on word count, or presence/absence of the content summaries). As such, the scope of the training set 410, and thus the model 402, may be broadened based on the historical data 450.

Once the training set 410 has been compiled or otherwise identified, the model module 310 then constructs the model 402 (e.g., with the training set 410 as the input). The training set 410 represents text information extracted from or otherwise associated with the various content items 432, 442, 452 and users 420, 422. The model module 310 builds the model 402 as a sparse representation model. This modeling may be described, generally, as a sparse vector transforming model, T, that converts raw text information, r, into a sparse vector, s:

s=T(r).

For content items 442, 452, r includes the text of the content summaries 444, or 454 (e.g., concatenation of a title and a summary description of an article), or, in some embodiments, the full text of the content item 432, 442, 452 (e.g., the full text of a post). For users 420, 422, r includes the user data 430 (e.g., concatenation of the user summary 436 and the content summaries 434 for the user 420).

In the example embodiment, the model module 310 uses term frequency—inverse document frequency (TF-IDF) to construct the model 402. In other embodiments, the model module 310 may construct a “doc2vec” model. Under TF-IDF, the model module 310 may be built using a broad dataset. For example, the model module 310 may accumulate all the posted articles during a certain period of time (e.g., as the historical data 450 from the social network system 210). Each of the articles may be treated as a document, and the whole set of articles are treated as the corpus with which to train the model 402.

In some embodiments, the model module 310 may build the model based on single keywords, or “unigrams.” Use of unigrams provides a computational simplicity to model building and application, but may sacrifice some semantic value from multi-word phrases. As such, in the example embodiment, the model module 310 builds the model based on unigrams and bigrams (e.g., single-word keywords, and two-word keywords, or “bigrams” as the input data set for training the model). For example, unigrams for position-level information from the user summary 436 may include “manage,” “sales,” “engineer,” “director,” and so forth, where bigrams from the user summary 436 may include “big data,” “data mining,” “platform architect,” and so forth. Expanding the model building to include both unigrams and bigrams adds some computational complexity, but also adds significant value by capturing greater semantic from the multi-word phrases. For example, the terms “platform” and “architect”, when on their own, may not properly represent someone who is a “platform architect.”

In one example embodiment, to build the model 402, the model module 310 parses and cleans these documents prior to use (e.g., removing non-English or non-alphabetical terms). Then the model module 310 may generate unigrams and bigrams for each of the articles. All of the resultant unigrams and bigrams then become the “dictionary pool” for the model 402, where each distinct unigram or bigram becomes a dictionary term. In some embodiments, some rare terms are removed from or otherwise not included in the dictionary pool (e.g., terms occurring 5 times or fewer may be removed). Once the dictionary pool of terms is identified, the model module 310 uses TF-IDF to build its weights, where each weight is a statistical measure used to evaluate how significant the term is within a document relative to the collection or corpus. The importance increases proportionally based on the number of times the term appears in the document, but is offset by the frequency of the term in the corpus. The TF-IDF weight is composed by two values. The first value is the normalized term frequency (TF) (e.g., the number of times a word appears in a document, divided by the total number of words in that document). In other words, TF measures how frequently the term occurs in the document. Since every document is different in length, it is possible that a term would appear many more times in a longer document than a shorter one. Thus, the term frequency is divided by the document length (e.g., the total number of terms or words in the document, as a means for normalization). The second value is the inverse document frequency (IDF) (e.g., the logarithm of the number of documents in the corpus divided by the number of documents where the specific term appears). IDF measures how important a term is. Under unmodified TF, all terms are considered equally important. However, certain terms such as “is”, “of”, and “that” may appear numerous times, but have little importance (e.g., to document relevance to the user 420). As such, IDF reduces the weight of the frequent terms while increasing the weight of the rare terms. In some embodiments, the model module 310 uses TF. In the example embodiment, the model module 310 uses TF-IDF.

The model 402, once constructed, includes a dictionary of terms (e.g., unigrams and bigrams) built from the terms found across all of the training set 410. The model 402 is configured to generate and output a sparse representation vector (or just “output vector”) from an “input document” (e.g., content items 432, 442, 452, or summaries 436, 434, 444, 454). As such, the summaries 436, 434, 444, 454 may be converted by the model 402 into a sparse vector under TF-IDF, using the dictionary of the model 402. In other words, the output vector for a particular content item, or associated summary, is an output vector of terms, where each term represents a single unigram or bigram of the dictionary, and where the value of that term in the output vector represents a term frequency of that dictionary term within the document (e.g., in the content item), which may be adjusted or scaled based on the inverse document frequency (e.g., how common or rare that term is across all documents). The dictionary of terms may include thousands of terms (e.g., as impacted by the selection of the training set 410). As such, the output vector for a given input document often results in a sparse vector, or one in which most term values are zero (e.g., because most terms do not occur in the given input document). In the example embodiment, in which summaries 436, 434, 444, 454 are used in lieu of the full text of the associated content items 432, 442, 452, the dictionary size is reduced, limiting the length of each output vector, as well as the computational burden required to apply the model 402. Use of the model 402 is described in greater detail below, with regard to FIG. 5.

FIG. 5 is a data flow diagram illustrating the content analysis engine 206 applying the model 402 to evaluate relevance of the current content items 442 to the user 420. After the model 402 is trained as described above, the content analysis engine 206 (e.g., via the user analysis module 320 or the content item analysis module 330) applies the user data 430 and the current content item data 440 to the model 430 to generate a user vector 520 and an item vector 530 (e.g., one for each current content item 442). The user vector 520 will then be compared to the item vectors 530 to determine a relative relevance of the user 420 to each of the current content items 442.

More specifically, in the example embodiment, the content analysis engine 206 combines the user summary 436 and the content summaries 434 of the user data into a combined summary 510 representing the user data 430. For example, the text of the content summaries 434 and the text of the user summary 436 may be concatenated together into the combined summary 510, which is a single text document that is used as the input to the model 402 to generate the user vector 520. The combined summary 510 thus includes text representing the more static data describing the user 420 (e.g., the user summary 436) and the more dynamic data describing the content items of recent interest to the user 420 (e.g., the content summaries 434 of past content items 432 that the user 420 has engaged with or otherwise consumed in the recent past). As such, all of the text or this user data 430 is combined and results in a single user vector 520 embodying all of that text.

To generate the item vectors for the current content items 442, the content analysis engine 206 individually submits each content summary 444 for the associated current content item 442 to the model 402 to generate a separate item vector for each content item 442. In other words, in the example embodiment, it is the summary text of the current content item 442 that is used to generate the item vector for the associated content item 442. In some embodiments, the entire text of the current content item 442 may be used as input to the model 402. In some embodiments, a title of the content item 442 and a summary of the content item 442 may be combined (e.g., concatenated) into the content summary 444. The item vectors 530 each represent a single current content item 442, and the text used to represent that item 442 (e.g., the content summary 444).

The content analysis engine 206 (e.g., the comparison module 340) then evaluates the user 420 relative to each of the current content items 442 for relevance. More specifically, a similarity value is computed for the user (e.g., as represented by the user vector 520) relative to each individual current content item (e.g., as represented by the associated item vector 530), or the pair (user 420, content item 442). The similarity function, in the example embodiment, is cosine-similarity:

$$similarity value = cos θ = \frac{A \cdot B}{‖ A ‖ ‖ B ‖} = \frac{{\sum }_{i = 1}^{n} {A}_{i} \times {B}_{i}}{\sqrt{{\sum }_{i = 1}^{n} {( {A}_{i} )}^{2}} \times \sqrt{{\sum }_{i = 1}^{n} {( {B}_{i} )}^{2}}} ,$$

where A represents the item vector 530 of the associated content item 442, and where B represents the user vector 520 of the user 420, and where n is the number of keywords (e.g., unigrams+bigrams) built into the model 402 (e.g., which may be large). Further, in some embodiments, the content analysis engine 206 computes only the non-zero terms of the vectors A and/or B. This leverages the nature of the spare vectors 520, 530 to reduces the computational burden.

The similarity value is thus used as a strength of relevance between the user 420 and each particular current content item 442. Once the content analysis engine 206 computes a similarity value for each of the (user 420, item vector 530) pairs, the content analysis engine 206 selects one or more current content items 442 for presentation to the user 420 based on the similarity scores. For example, in some embodiments, the content analysis engine 206 may rank the current content items 442 based on the similarity values and select a pre-determined number of content items with the highest similarity scores for presentation to the user 420. In other embodiments, the content analysis engine 206 may select only the current content items 442 having a similarity value above a pre-determined threshold.

In some embodiments, the content analysis engine 206 ranks the current content items 442 within a certain topic or category (e.g., selected by the user 420), and promotes the most relevant current content items 442 from the selected topic based on the similarity value. In some embodiments, the user 420 may preselect the topic(s), and the content analysis engine 206 may use the similarity value as weights joined together with the weights of the topic (e.g., 1-selected, 0-not select) to generate the final ranking. For example, the final strength of relevance may be computed by multiplying the similarity values with the indicator of the topic. In some embodiments, the similarity value may be used by collecting multiple users who have similar values for a given content item, and use profile information from those multiple users to understand the article better (e.g., the article theme, topic, or source).

In some embodiments, the content analysis engine 206 may use the similarity values to recommend topics for users to follow. For example, if two users have very similar interests in contents, but one is following a topic that the other is not, the content analysis engine 206 may send content items with high similarity values for the topic to the user who is not yet following the topic (e.g., as an introduction, to show what the topic is like). Based on that presentation, the user may elect to follow that topic in the future.

Further, in the example embodiment, the content analysis engine 206 may generate a user vector 520 for each user 420, 422 in the community 424, generate the similarity scores for each (user 422, current content item 442) pair, and select a set of current content items 442 for that particular user 422 (e.g., tailored for relevance to that user 422).

In addition, in some embodiments, the content analysis engine 206 may apply these methods to multiple communities 424, where each community 424 may have a different set of users 422, a different set of current content items 442, and/or a different set of training content items 452. As such, the content analysis engine 206 may build models 402 individualized or customized for multiple distinct communities 424, and may rebuild models 402 on a regular basis, such as when a new set of current content items 442 is to be sent out to the community 424.

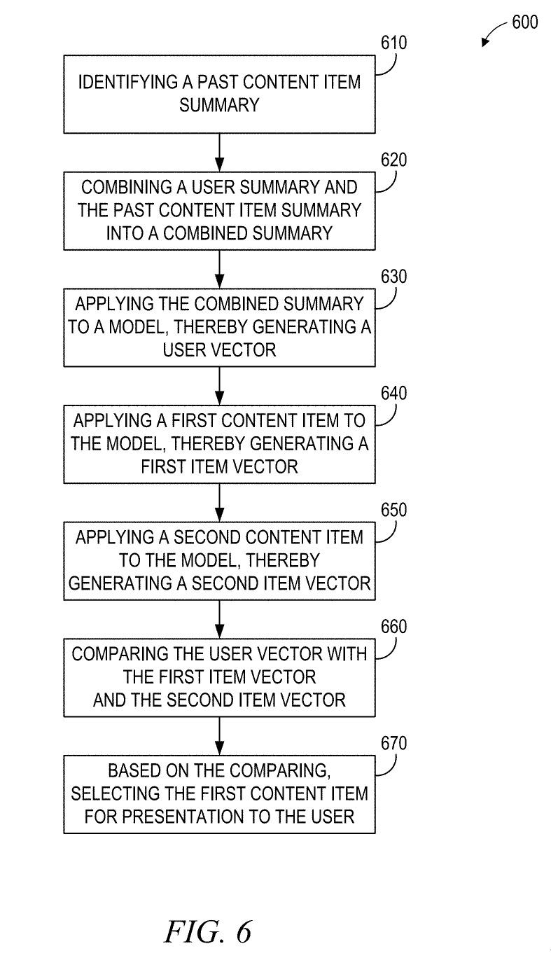

FIG. 6 is a flow chart illustrating operations of the skills analysis engine 206 in performing a method 600 for evaluating relevance of content items 442 for a user 420 of a social network 210, according to various embodiments. Operations in the method 600 may be performed by the network-based system 105, using modules described above with respect to FIG. 3. As shown in FIG. 6, the method 600 includes operations 610, 620, 630, 640, 650, 660, and 670.

At operation 610, the method 600 includes identifying a past content item from historical content engagement information associated with a user in the memory, the past content item including a past content item summary. At operation 620, the method 600 includes combining a user summary associated with the user and the past content item summary, thereby generating a combined summary. At operation 630, the method includes applying, with the hardware processor, the combined summary to a model, thereby generating a user vector having a plurality of terms, each term of the plurality of terms representing one of a word and a word-phrase in a dictionary of terms of the model.

At operation 640, the method 600 includes applying, with the hardware processor, a first content item to the model, thereby generating a first item vector. In some embodiments, applying the first content item to the model includes applying a first content summary associated with the first content item to the model to generate the first item vector. At operation 650, the method 600 includes applying, with the hardware processor, a second content item to the model, thereby generating a second item vector. At operation 660, the method 600 includes comparing, with the hardware processor, the user vector with the first item vector and the second item vector. At operation 670, the method 600 includes selecting the first content item for presentation to the user based on the comparing.

In some embodiments, the method 600 includes constructing the model, with the hardware processor, using term frequency-inverse document frequency (TF-IDF). In some embodiments, the historical content engagement information includes content summaries for a plurality of past content items with which the user has engaged, and the method 600 further includes training the model using at least the content summaries for the plurality of past content items. In some embodiments, the method 600 further includes training the model with one or more bigrams of an input data set. In some embodiments, the method 600 further includes training the model using the user summary. In some embodiments, the method 600 further includes computing, with the hardware processor, a first similarity value between the first item vector and the user vector, and computing, with the hardware processor, a second similarity value between the second item vector and the user vector, wherein comparing the user vector with the first item vector and the second item vector includes comparing the first similarity score to the second similarity score.

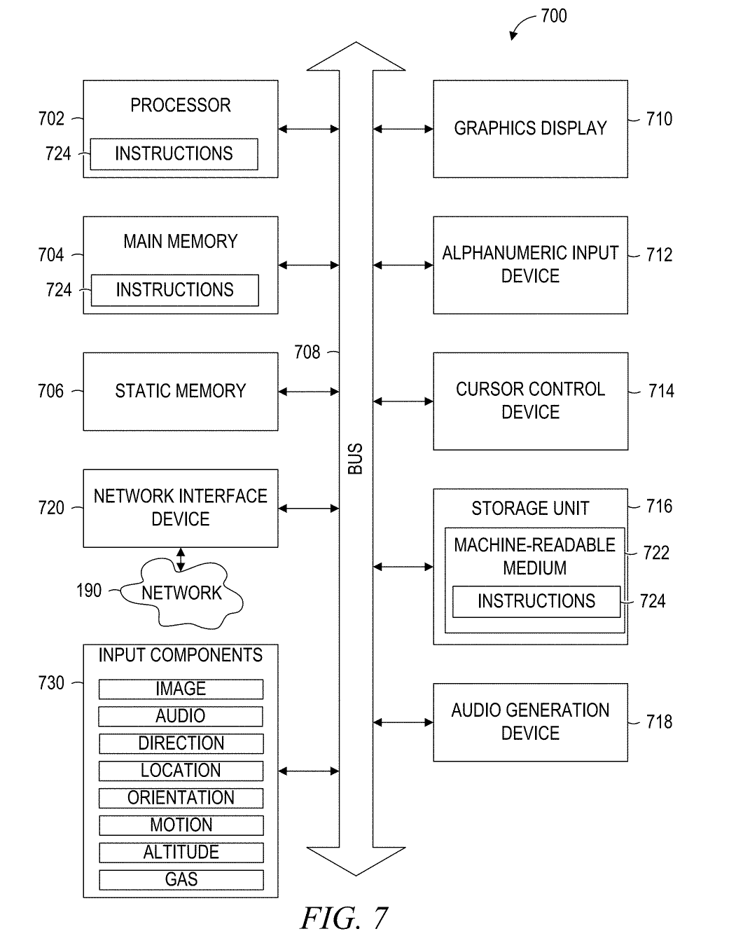

FIG. 7 is a block diagram illustrating components of a machine 700, according to some example embodiments, able to read instructions 724 from a machine-readable medium 722 (e.g., a non-transitory machine-readable medium, a machine-readable storage medium, a computer-readable storage medium, or any suitable combination thereof) and perform any one or more of the methodologies discussed herein, in whole or in part. In some embodiments, the machine 500 is similar to the networked system 105, or the social network system 210, or the content analysis engine 206. Specifically, FIG. 7 shows the machine 700 in the example form of a computer system (e.g., a computer) within which the instructions 724 (e.g., software, a program, an application, an applet, an app, or other executable code) for causing the machine 700 to perform any one or more of the methodologies discussed herein may be executed, in whole or in part. When configured as described herein, the machine 700 becomes a special-purpose machine 700 specifically configured to perform the systems and methods described herein.

In alternative embodiments, the machine 700 operates as a standalone device 130, 150 or may be connected (e.g., networked) to other machines. In a networked deployment, the machine 700 may operate in the capacity of a server machine 110 or a client machine in a server-client network environment, or as a peer machine in a distributed (e.g., peer-to-peer) network environment. The machine 700 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 724, sequentially or otherwise, that specify actions to be taken by that machine. Further, while only a single machine 700 is illustrated, the term “machine” shall also be taken to include any collection of machines 700 that individually or jointly execute the instructions 724 to perform all or part of any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a graphics display 710 (e.g., a plasma display panel (PDP), a light emitting diode (LED) display, a liquid crystal display (LCD), a projector, a cathode ray tube (CRT), or any other display capable of displaying graphics or video). The machine 700 may also include an alphanumeric input device 712 (e.g., a keyboard or keypad), a cursor control device 714 (e.g., a mouse, a touchpad, a trackball, a joystick, a motion sensor, an eye tracking device, or another pointing instrument), a storage unit 716, an audio generation device 718 (e.g., a sound card, an amplifier, a speaker, a headphone jack, or any suitable combination thereof), and a network interface device 720.

The storage unit 716 includes the machine-readable medium 722 (e.g., a tangible and non-transitory machine-readable storage medium) on which are stored the instructions 724 embodying any one or more of the methodologies or functions described herein. The instructions 724 may also reside, completely or at least partially, within the main memory 704, within the processor 702 (e.g., within the processor's cache memory), or both, before or during execution thereof by the machine 700. Accordingly, the main memory 704 and the processor 702 may be considered machine-readable media 722 (e.g., tangible and non-transitory machine-readable media). The instructions 724 may be transmitted or received over the network 190 via the network interface device 720. For example, the network interface device 720 may communicate the instructions 724 using any one or more transfer protocols (e.g., Hypertext Transfer Protocol (HTTP)).

In some example embodiments, the machine 700 may be a portable computing device, such as a smartphone or tablet computer, and may have one or more additional input components 730 (e.g., sensors or gauges). Examples of such input components 730 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components 730 may be accessible and available for use by any of the modules described herein.

As used herein, the term “memory” refers to a machine-readable medium 722 able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database, or associated caches and servers) able to store instructions 724. The term “machine-readable medium” shall also be taken to include any medium, or combination of multiple media, that is capable of storing the instructions 724 for execution by the machine 700, such that the instructions 724, when executed by one or more processors of the machine 700 (e.g., processor 702), cause the machine 700 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component.

Similarly, structures and functionality presented as a single component may be implemented as separate components. These and other variations, modifications, additions, and improvements fall within the scope of the subject matter herein.

Certain embodiments are described herein as including logic or a number of components, modules, engines, or mechanisms. Modules or engines may constitute software modules (e.g., code stored or otherwise embodied on a machine-readable medium 722 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors 702) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 702 or other programmable processor 702. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor 702 configured by software to become a special-purpose processor, the general-purpose processor 702 may be configured as respectively different special-purpose processors (e.g., comprising different hardware modules) at different times. Software (e.g., a software module) may accordingly configure one or more processors 702, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 708) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 702 that are temporarily configured (e.g., by software) or permanently configured to perform the relevant operations. Whether temporarily or permanently configured, such processors 702 may constitute processor-implemented modules that operate to perform one or more operations or functions described herein. As used herein, “processor-implemented module” refers to a hardware module implemented using one or more processors 702.

Similarly, the methods described herein may be at least partially processor-implemented, a processor 702 being an example of hardware. For example, at least some of the operations of a method may be performed by one or more processors 702 or processor-implemented modules. As used herein, “processor-implemented module” refers to a hardware module in which the hardware includes one or more processors 702. Moreover, the one or more processors 702 may also operate to support performance of the relevant operations in a “cloud computing” environment or as a “software as a service” (SaaS). For example, at least some of the operations may be performed by a group of computers (as examples of machines 700 including processors 702), with these operations being accessible via a network 190 (e.g., the Internet) and via one or more appropriate interfaces (e.g., an application programming interface (API)).

The performance of certain operations may be distributed among the one or more processors 702, not only residing within a single machine 700, but deployed across a number of machines 700. In some example embodiments, the one or more processors 702 or processor-implemented modules may be located in a single geographic location (e.g., within a home environment, an office environment, or a server farm). In other example embodiments, the one or more processors 702 or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine 700. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine 700 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A content analysis system comprising:
one or more hardware processors;
a memory storing:
historical content engagement information associated with a user;
a user summary associated with the user;
a first content item including a first content summary; and
a second content item including a second content summary; and
a content analysis engine, executing on the one or more hardware processors, configured to:
identify a past content item from the historical content engagement information, the past content item including a past content item summary;
combine the user summary and the past content item summary, thereby generating a combined summary;
apply the combined summary to a model, thereby generating a user vector having a plurality of terms, each term of the plurality of terms representing one of a word and a word-phrase in a dictionary of terms of the model;
apply the first content item to the model, thereby generating a first item vector;
apply the second content item to the model, thereby generating a second item vector;
compare the user vector with the first item vector and the second item vector; and
based on the comparing, select the first content item for presentation to the user.

2. The content analysis system of claim 1, wherein the content analysis engine is further configured to construct the model using term frequency-inverse document frequency (TF-IDF).

3. The content analysis system of claim 1, wherein the historical content engagement information includes content summaries for a plurality of past content items with which the user has engaged, wherein the content analysis engine is further configured to train the model using at least the content summaries for the plurality of past content items.

4. The content analysis system of claim 1, wherein the content analysis engine is further configured to train the model with one or more bigrams of an input data set.

5. The content analysis system of claim 1, wherein the content analysis engine is further configured to train the model using the user summary.

6. The content analysis system of claim 1, wherein applying the first content item to the model includes applying a first content summary associated with the first content item to the model to generate the first item vector.

7. The content analysis system of claim 1, wherein the content analysis engine is further configured to:
generate a first similarity value between the first item vector and the user vector;
generate a second similarity value between the second item vector and the user vector,
wherein comparing the user vector with the first item vector and the second item vector includes comparing the first similarity score to the second similarity score.

8. A computer-implemented method performed using a hardware processor and a memory, the method comprising:
identifying a past content item from historical content engagement information associated with a user in the memory, the past content item including a past content item summary;
combining a user summary associated with the user and the past content item summary, thereby generating a combined summary;
applying, with the hardware processor, the combined summary to a model, thereby generating a user vector having a plurality of terms, each term of the plurality of terms representing one of a word and a word-phrase in a dictionary of terms of the model;
applying, with the hardware processor, a first content item to the model, thereby generating a first item vector;
applying, with the hardware processor, a second content item to the model, thereby generating a second item vector;
comparing, with the hardware processor, the user vector with the first item vector and the second item vector; and
based on the comparing, selecting the first content item for presentation to the user.

9. The method of claim 8, further comprising constructing the model, with the hardware processor, using term frequency-inverse document frequency (TF-IDF).

10. The method of claim 8, wherein the historical content engagement information includes content summaries for a plurality of past content items with which the user has engaged, the method further comprising training the model using at least the content summaries for the plurality of past content items.

11. The method of claim 8, further comprising training the model with one or more bigrams of an input data set.

12. The method of claim 8, further comprising training the model using the user summary.

13. The method of claim 8, wherein applying the first content item to the model includes applying a first content summary associated with the first content item to the model to generate the first item vector.

14. The method of claim 8, further comprising:
computing, with the hardware processor, a first similarity value between the first item vector and the user vector; and
computing, with the hardware processor, a second similarity value between the second item vector and the user vector,
wherein comparing the user vector with the first item vector and the second item vector includes comparing the first similarity score to the second similarity score.

15. A non-transitory machine-readable medium storing processor-executable instructions which, when executed by a processor, cause the processor to:
identify a past content item from historical content engagement information associated with a user in the memory, the past content item including a past content item summary;
combine a user summary and the past content item summary, thereby generating a combined summary;
apply the combined summary to a model, thereby generating a user vector having a plurality of terms, each term of the plurality of terms representing one of a word and a word-phrase in a dictionary of terms of the model;
apply a first content item to the model, thereby generating a first item vector;
apply a second content item to the model, thereby generating a second item vector;
compare the user vector with the first item vector and the second item vector; and
based on the comparing, select the first content item for presentation to the user.

16. The machine-readable medium of claim 15, wherein the processor-executable instructions further cause the processor to construct the model, with the hardware processor, using term frequency-inverse document frequency (TF-IDF).

17. The machine-readable medium of claim 15, wherein the historical content engagement information includes content summaries for a plurality of past content items with which the user has engaged, wherein the processor-executable instructions further cause the processor to train the model using at least the content summaries for the plurality of past content items.

18. The machine-readable medium of claim 15, wherein the processor-executable instructions further cause the processor to train the model with one or more bigrams of an input data set.

19. The machine-readable medium of claim 15, wherein applying the first content item to the model includes applying a first content summary associated with the first content item to the model to generate the first item vector.

20. The machine-readable medium of claim 15, wherein the processor-executable instructions further cause the processor to:
compute a first similarity value between the first item vector and the user vector;
compute a second similarity value between the second item vector and the user vector,
wherein comparing the user vector with the first item vector and the second item vector includes comparing the first similarity score to the second similarity score.
